(19) United States
(12) Patent Application Publication
(10) Pub. No.: US 2020/0059002 A1
(43) Pub. Date: Feb. 20, 2020

(54) ELECTROMAGNETIC ANTENNA

(71) Applicant: THALES, Courbevoie (FR)

(72) Inventors: Christian RENARD, Elancourt (FR); Eric VINAY, Elancourt (FR); Eric ESTEBE, Elancourt (FR)

(21) Appl. No.: 16/496,224

(22) PCT Filed: Mar. 22, 2018
(86) PCT No.: PCT/EP2018/057297

§ 371 Date: Sep. 20, 2019

(30) Foreign Application Priority Data
Mar. 23, 2017 (FR) 17 00304

(51) Int. Cl. H01Q 13/22; H01Q 21/00; H01Q 13/10

(52) U.S. Cl. CPC H01Q 13/22; H01Q 13/10; H01Q 21/0087; H01Q 21/0043

(57) ABSTRACT

The invention relates to an electromagnetic antenna having a first electromagnetic waveguide radiating part of predetermined geometric shape, forming a first electromagnetic propagation medium and having, a first radiation wall having a plurality of spaced-apart radiating slots, each radiating slot extending in a first longitudinal direction, and a second wall, opposite the first wall. The antenna has a second active part comprising a stack of at least two dielectric layers, at least one of the dielectric layers being etched with at least one metal track, resulting in at least one active circuit, forming a second electromagnetic propagation medium, at least one portion of said second active part being pressed against said second wall in a contact area. A coupling slot is situated in said contact area, the coupling slot passing through said second wall and extending in a second direction forming a nonzero angle of orientation with said first longitudinal direction.

### CROSS-REFERENCE TO RELATED APPLICATIONS

This application is a National Stage Entry of International Patent Application No. PCT/EP2018/057297, filed Mar. 22, 2018, which claims priority to French Patent Application No. 17 00304, filed Mar. 23, 2017. The disclosures of the priority applications are incorporated in their entirety herein by reference.

### FIELD OF THE INVENTION

The present invention relates to an electromagnetic antenna of the type having a first electromagnetic waveguide radiating part of predetermined geometric shape.

The invention falls within the field of partially active or passive electromagnetic antennas, used in the field of radars or radiocommunication.

### BACKGROUND OF THE INVENTION

In a known manner, for partially active or passive antennas, such as distributed amplification antennas, electrical losses occur related to the distribution of the power of the signal that are detrimental to the efficiency of the antenna. In particular, the radiated power and/or the sensitivity of the antenna on reception are decreased. As a result, a system using such antennas, for example a radar, will have a limited range.

Furthermore, aside from the limitations due to electrical losses, it is also useful to incorporate one or several active circuits into the antennas, for example amplifiers or phase shifters, for processing of the signal sent or received by such an antenna, in order to obtain a more compact active antenna.

So-called slot antennas are known, including a radiating part made up of a waveguide including radiating slots. Such antennas offer the advantage of having low electrical losses, but do not allow an easy integration of active circuits.

Also known are antennas made up of a stack of layers of dielectric substrates, etched with metal tracks, the coupling between layers being obtained by means of metallized holes, also called vias, or by electromagnetic coupling by opening or by proximity. However, such antennas with stacks of layers generally have significant electrical losses.

Furthermore, in many applications, it is useful to have antennas with a reduced bulk.

It is therefore useful to propose improved antennas, having low electrical losses and a reduced bulk while allowing an easy connection to active circuits.

### SUMMARY OF THE INVENTION

To that end, the invention proposes an electromagnetic antenna having a first electromagnetic waveguide radiating part of predetermined geometric shape, forming a first electromagnetic propagation medium and having a first radiation wall having a plurality of spaced-apart radiating slots, each radiating slot extending in a first longitudinal direction, and a second wall, opposite the first radiation wall.

The antenna has a second active part comprising a stack of at least two dielectric layers, at least one of the dielectric layers being etched with at least one metal track, resulting in at least one active circuit, forming a second electromagnetic propagation medium, at least one portion of said second active part being pressed against said second wall in a contact area. Furthermore, the antenna has a coupling slot situated in said contact area, the coupling slot passing through said second wall, said coupling slot extending in a second direction forming a nonzero angle of orientation with said first longitudinal direction.

Advantageously, the electromagnetic antenna according to the invention has low electrical losses owing to a radiating surface similar to the radiating surface of a conventional slot guide antenna. Furthermore, the coupling slot makes it possible to minimize the bulk, no additional coupling or connection element being added.

Advantageously, the electromagnetic antenna according to the invention may have one or more of the features below, considered independently or in combination, according to all technically acceptable combinations.

The second active part includes a metallized layer etched on an upper dielectric layer of the stack, said metallized layer being pressed against the second wall of the waveguide, and the coupling slot is formed by two parts, a first part passing through said second wall and a second part passing through said metallized layer.

The second active part includes a metallized layer etched on an upper dielectric layer of the stack, said metallized layer forming said second wall of the waveguide.

The first radiation wall has a plurality of radiating slots positioned in a predetermined regular grid, and the coupling slot is located across from an area without slots of the first wall.

The waveguide of the first radiating part is a waveguide with a rectangular section, said first wall and second wall being substantially parallel.

The coupling slot is centered relative to the second wall of the waveguide.

The angle of orientation is substantially equal to 45 degrees.

The second propagation medium has an associated wavelength, and the second active part includes a transmission line printed between two stacked dielectric layers, the transmission line including a termination portion, the length of which is a function of said wavelength associated with the second propagation medium.

### BRIEF DESCRIPTION OF THE DRAWINGS

Other features and advantages of the invention will emerge from the description thereof provided below, for information and non-limitingly, in reference to the appended figures, in which:

FIG. 1 is an exploded schematic view of an electromagnetic antenna according to a first embodiment of the invention;

FIG. 2 is a schematic top view of the antenna of FIG. 1;

FIG. 3 is a schematic view of an electromagnetic antenna according to a second embodiment of the invention.

### DETAILED DESCRIPTION OF EMBODIMENTS

According to one embodiment, an electromagnetic antenna 10 includes a first radiating part 12 and a second active part 14 suitable for being connected to or comprising at least one active circuit 50.

For example, the active circuit is an amplifier or a phase shifter.

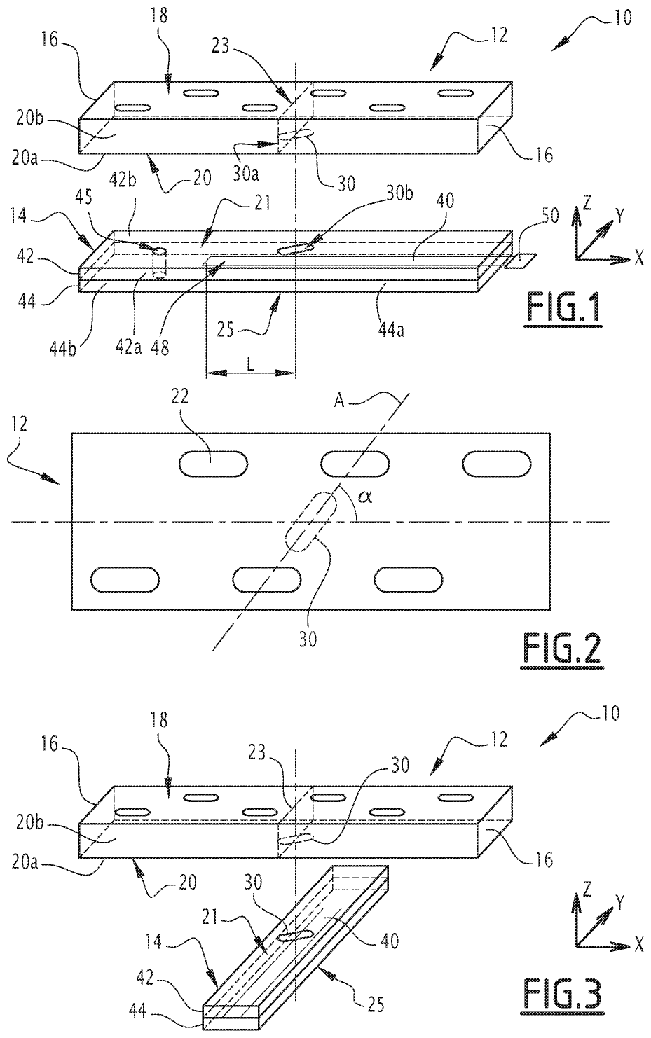

FIG. 1 schematically shows the first radiating part 12 and the second active part 14, in exploded perspective view.

The first radiating part 12 is of the slot waveguide type, as explained in more detail hereinafter. This first radiating part of the antenna makes up a first electromagnetic propagation medium.

The second active part is made up of a stack of layers of dielectric substrates etched with metallic tracks, the connections of one layer to the other being done by means of metallized holes, also called vias. The active part of the antenna makes up a second electromagnetic propagation medium.

The first radiating part 12 comprises a waveguide 16 of predetermined geometric shape, which is a parallelepiped waveguide, therefore with a rectangular section, in the illustrated example.

In a variant, a waveguide 16 having another geometric shape can be considered, for example having a ridge in order to increase its frequency band.

For example, the waveguide 16 is made from a metallic material, and has walls with a given thickness, and is filled with air, or completely or partially filled with a first dielectric material.

The waveguide 16 comprises a first wall 18, called radiating wall, and a second wall 20, which is opposite the first wall 18.

When the waveguide 16 has a parallelepiped shape, the first wall 18 and the second wall 20 are substantially parallel.

On the first wall 18, which is the radiating wall, at least two radiating slots 22 are formed.

Each radiating slot 22 is an opening arranged in the thickness of the first wall 18, with a given shape, size and orientation, allowing a controlled radiation of the electromagnetic waves.

Preferably, several radiating slots 22 are positioned in a regular grid, along the directions X, Y of the plane. The shape, size, orientation and position of the radiating slots make it possible to define the radiation pattern of the antenna.

For example, the direction X is the longitudinal direction, the direction Y is the transverse direction, and the direction Z is the direction orthogonal to the plane (X,Y), so as to form an orthonormal spatial coordinate system (X,Y,Z).

Two successive radiating slots in a given direction are spaced apart by a predetermined distance.

In the example, each radiating slot 22 has a rectangular shape with rounded corners as shown in FIG. 1, extending in a first direction, which is the longitudinal direction X.

In one embodiment, all of the radiating slots formed in the first wall 18 of the waveguide have the same geometric shape and the same dimensions. In a variant, the radiating slots 22 have a similar shape, but different dimensions.

The first wall 18 includes, between the slots, areas 23 without slots, also called non-radiating areas.

The waveguide performs the distribution of an electromagnetic signal toward the radiating slots 22.

In FIG. 1, the first radiating part 12 and the second active part 14 have been shown separated to facilitate the explanation.

In practice, the first radiating part 12 and the second active part 14 are pressed against one another, with no separation between these two parts.

In the embodiment of FIG. 1, the first radiating part 12 and the second active part 14 are aligned longitudinally and are pressed against one another, the outer face 20a of the second wall 20 being adhered to an upper layer of the second active part and forming a contact area.

The first radiating part 12 and the second active part 14 are coupled by a coupling slot 30, located in the contact area and which passes through the second wall 20 up to an upper dielectric layer of the stack forming the second active part. The dielectric layers of the second active part are made with a second dielectric material.

The coupling slot 30 extends in a second direction A forming a nonzero angle of orientation, denoted α, with the first direction X. Here, the angle of orientation refers to the acute angle formed between the first direction X and the second direction A.

The coupling slot 30 is placed across from the first wall 18 of the waveguide 16, at an area without slots 23, that is to say, located between two successive slots.

Here, placement of an element across from an area refers to a position of the element without contact with the considered area, and such that the axis of electromagnetic radiation of this device is comprised in said area.

In one embodiment, the coupling slot 30 is centered relative to the second wall 20.

The nonzero angle of orientation α, visible in a schematic illustration in FIG. 2, is preferably substantially equal to 45°.

When the coupling slot 30 is placed at a distance equal to one quarter of the guided wavelength of the radiating slots 22 along the longitudinal axis X, it does not disrupt the radiation, and is functionally similar to a transformation toward the second active part 14.

Advantageously, the waveguide 16 is excited by means of the coupling slot 30, which makes it possible to create a direct link with the stacked dielectric layers of the second active part 14, and to distribute an electromagnetic signal coming from the active circuit between access of the antenna and the radiating slots.

In the illustrated embodiment, the second active part 14 is a printed circuit board of the tri-plate type and includes two stacked dielectric layers, respectively denoted 42, 44. The shielding intended to block the propagation of stray electromagnetic modes is done by a set of metallized holes 45, only one of which is symbolically shown in FIG. 1. In a variant, a printed circuit board of the micro-ribbon type is used.

Each dielectric layer 42, 44 has a lower face 42a, 44a, and an upper face 42b, 44b.

A printed segment 40, forming a transmission line, is printed between the two dielectric layers, either on the lower face of the layer 42, or on the upper face of the layer 44.

Several embodiments of the coupling slot are considered, as outlined below.

In a first embodiment, the layer 42 is at least partially covered, on its upper face 42b, with a metallized layer 21 forming a first earth plane P1. In this first embodiment, the coupling slot 30 is made in two parts, a first part formed by the slot 30a that passes through the second metal wall 20, and a second part formed by the slot 30b that passes through the metallized layer 21.

Preferably, the two parts 30a and 30b of the coupling slot 30 have the same shape and are aligned on all of the edges. In one practical embodiment, the slots 30a and 30b are made separately, the coupling slot 30 being made when the first radiating part and the second active part are assembled.

In a second embodiment, the metallized layer 21 is replaced by the second wall 20 of the waveguide 16, when the latter is in earth continuity with the upper face 42b of the layer 42. In this case, the first earth plane P1 is formed by the second wall 20, and the coupling is done by the coupling slot 30a formed in the second wall 20 of the waveguide.

In a third embodiment, the layer 42 includes a metallized layer 21 on its upper face, and the metallized layer 21 makes up the second wall 20 of the waveguide 16. In this embodiment, the coupling slot 30 is formed by the slot 30b made in the metallized layer 21.

The layer 44 is at least partially covered, on its lower face 44a, with a metallized layer 25 forming a second earth plane P2.

The printed segment 40 is connected to an active circuit 50, for example an amplifier or a phase shifter.

The example of FIG. 1 comprises only two stacked dielectric layers, but of course, this is an example, and any other number of stacked layers can be considered.

The equivalent electrical diagram of the ‘circuit’ type of the inclined coupling slot 30 is made up of an impedance inserted in series on a line.

The transmission line 40 terminates at its other end with a termination portion 48 in an open circuit, also called “stub”, the impedance of which brought to the coupling slot allows total coupling of the energy toward the radiation guide 16.

In order to bring an open circuit back at the coupling slot, the termination portion 48 has a length L=L₀+kLᵢ/2, with k a positive or zero integer, L, the wavelength in the printed propagation medium and Lo close to 0.

In one embodiment, k=1 is selected.

In the embodiment illustrated schematically in FIG. 3, the electromagnetic antenna also includes a first radiating part and a second active part that are coupled by means of an inclined coupling slot.

Unlike the embodiment of FIG. 1, the second active part is arranged at a right angle relative to the longitudinal direction of the first radiating part.

In the embodiment of FIG. 3, when the antenna is assembled, the first radiating part and the second active part are pressed against one another on a metallic portion forming a contact area. Similarly to what was described above for the embodiment of FIG. 1, the metallic portion forming a contact area is either made by adhering a portion of the second wall of the waveguide and corresponding portion of an upper metallized layer of the second active portion, or by a portion of the second wall of the waveguide only, or by a portion of an upper metallized layer of the second active part only.

The coupling slot 30 passes through the metallic portion of the contact area up to the upper dielectric layer of the second active part.

Preferably, in this embodiment as well, the coupling slot 30 is oriented at 45°.

Thus, when a coupling slot 30 with an angle of orientation of 45° is made, it is possible to produce an antenna in which the first radiating part and the second active part are arranged in parallel or transversely, without having to perform an additional adaptation.

Advantageously, the electromagnetic antenna according to the invention comprises a radiating part in a waveguide having reduced ohmic losses, and an active part compatible with the establishment and implementation of active circuits.

Advantageously, the implementation of the coupling between the first radiating part and the second active part by an inclined coupling slot is easier to do than in the case where an additional coupling and connection element is added, the total bulk of the antenna is reduced and the ohmic losses are minimized.

1. An electromagnetic antenna having a first electromagnetic waveguide radiating part of predetermined geometric shape, forming a first electromagnetic propagation medium and having a first radiation wall having a plurality of spaced-apart radiating slots, each radiating slot extending in a first longitudinal direction, and a second wall, opposite the first radiation wall,
comprising a second active part comprising a stack of at least two dielectric layer, at least one of the dielectric layers being etched with at least one metal track, resulting in at least one active circuit, forming a second electromagnetic propagation medium, at least one portion of the second active part being pressed against the second wall in a contact area,
and further comprising a coupling slot situated in the contact area, the coupling slot passing through the second wall, the coupling slot extending in a second direction forming a nonzero angle of orientation with the first longitudinal direction.

2. The electromagnetic antenna according to claim 1, wherein the second active part includes a metallized layer etched on an upper dielectric layer of the stack, the metallized layer being pressed against the second wall of the waveguide, and the coupling slot is formed by two parts, a first part passing through the second wall and a second part passing through the metallized layer.

3. The electromagnetic antenna according to claim 1, wherein the second active part includes a metallized layer etched on an upper dielectric layer of the stack, the metallized layer forming the second wall of the waveguide.

4. The electromagnetic antenna according to to claim 1, wherein the first radiation wall has a plurality of radiating slots positioned in a predetermined regular grid, and the coupling slot is located across from an area without slots of the first wall.

5. The electromagnetic antenna according to claim 1, wherein the waveguide of the first radiating part is a waveguide with rectangular section, the first wall and second wall being substantially parallel.

6. The electromagnetic antenna according to claim 1, wherein the coupling slot is centered relative to the second wall of the waveguide.

7. The electromagnetic antenna according to claim 1, wherein the angle of orientation is substantially equal to 45 degrees.

8. The electromagnetic antenna according to claim 1, wherein the second electromagnetic propagation medium has an associated wavelength, and the second active part includes a transmission line printed between two stacked dielectric layers, the transmission line including a termination portion the length of which is a function of the wavelength associated with the second electromagnetic propagation medium.
